(19) United States
(12) Patent Application Publication
(10) Pub. No.: US 2009/0069208 A1
(43) Pub. Date: Mar. 12, 2009

(54) AQUEOUS DETERGENT COMPOSITIONS

(75) Inventors: Luca Libralesso, Mira (IT); Dora Zamuner, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/572,996

(22) PCT Filed: Aug. 3, 2005
(86) PCT No.: PCT/GB05/03055

§ 371 Date: Oct. 3, 2008

(30) Foreign Application Priority Data
Aug. 4, 2004 (GB) 0417332.4

(51) Int. Cl. C11D 7/42

(52) U.S. Cl. 510/321

(57) ABSTRACT

This invention relates to aqueous enzyme-containing liquid detergents, preferably for use as a laundry booster compositions either as a pre-wash composition or in conjunction with a laundry detergent, with good enzyme stability. The stability of the enzymes is improved by the inclusion of a hydrogen peroxide destroying agent, preferably catalase.

This invention relates to aqueous enzyme-containing liquid detergents, preferably for use as a laundry booster compositions either as a pre-wash composition or in conjunction with a laundry detergent, with good enzyme stability. The stability of the enzymes is improved by the inclusion of a hydrogen peroxide destroying agent, preferably catalase.

Enzyme-containing laundry booster compositions have been known for many years. A major problem encountered with such compositions has been the irreversible decay of enzyme activity during storage caused by the denaturisation of the enzymes. This problem is particularly acute when such compositions have to be transported or stored under conditions where temperatures of 40° C. or higher are encountered. Numerous enzyme stabilisation systems have been developed over the years but there is still room for improvement in such systems, particularly as regards cost effectiveness.

It is therefore a primary object of this invention to develop stabilised enzyme-containing laundry detergent composition which incorporates a low cost, but effective, stabilisation system. It is also an object of this invention to develop an enzyme-containing composition which is effective against a wide variety of fabric stains encountered in daily life such as blood, wine, grass and chocolate.

Many of the enzymes used in laundry detergents are sensitive to oxidation. Thus, the use of bleaching ingredients is especially avoided unless these two ingredients are spatially separated. However, in a liquid formulation this is extremely difficult.

Therefore, bleaching systems, i.e. hydrogen peroxide, is not added to liquid laundry detergents, that contain enzymes sensitive to oxidation.

We have found that even in zero hydrogen peroxide added liquid formulations enzyme stability is improved by the inclusion of a hydrogen peroxide destroying agent.

Whilst not wishing to be bound by theory we believe that hydrogen peroxide can be a common impurity in many commercially prepared surfactants. Examples are amine oxides.

The invention, in its first aspect, is directed to a liquid detergent composition comprising;
(a) an enzyme sensitive to oxidation;
(b) surfactant;
(c) a hydrogen peroxide destroying agent present in an amount of greater than 6 units/ml, preferably an enzyme; and
(d) water.

Preferably the hydrogen peroxide destroying agent is catalase.

Further, the invention is also directed (in a second aspect) to the use of a hydrogen destroying agent (preferably catalase) to stabilise liquid laundry detergent compositions containing an enzyme sensitive to oxidation.

The invention is also directed to the use of the above-described enzyme compositions as a laundry booster, stain treater, laundry detergent, etc.

Catalase is a common enzyme present in the cell of plants, animals and aerobic bacteria. It promotes the conversion of hydrogen peroxide to water and molecular oxygen. This reaction is very specific and very fast: catalase has one of the highest turnover rates for all enzymes. Catalase is inhibited by urea, freezing and sunlight under aerobic conditions. The effective amount of enzyme needed is greater than 6 units/ml (e.g. 6.3 units/ml), wherein one unit of enzyme activity is de-fined as that quantity required to convert 1 μmol. of substrate per minute under standard assay conditions.

The reaction is:

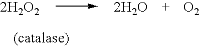

### Oxidation Sensitive Enzymes

The enzymes suitable for use in the compositions include protease and amylase enzymes.

The proteolytic enzymes suitable for the present compositions include the various commercial liquid enzyme preparations which have been adapted for use in association with detergent compositions. Enzyme preparations in powdered form are also useful although, as a general rule, less convenient for incorporation into liquid compositions. Suitable liquid enzyme preparations include “Alcalase”, “Savinase”, and “Esperase”, all trademarked products sold by Novo Industries, Copenhagen, Denmark, and “Maxatase”, “Maxacal”, and “AZ-Protease” and “Properase” sold by Gist-Brocades, Delft, The Netherlands.

Among the suitable alpha-amylase liquid enzyme preparations are those sold by Novo Industries and Gist-Brocades under the tradenames “Termamyl” and “Maxamyl”, respectively.

Mixtures of proteolytic and amylase enzymes can and often are used to assist in removal of different types of stains.

The proteolytic enzyme and/or amylase enzyme will normally be present in the compositions in an effective amount in the range of from about 0.05% to about 5%, preferably from about 0.5% to about 2%, by weight of the composition. Generally, lower levels of amylase are required.

### Additional Enzyme Stabilisers

A boron compound i.e. a compound capable of yielding boric acid and is, preferably, boric acid itself. Examples of compounds capable of producing boric acid are boric oxide and alkali metal borate, preferably sodium borate (borax). The boron compound is introduced in amounts of from about 0.1 to about 2.0 weight %, based on the weight of the entire enzyme-containing composition. Preferably, the boron compound is used in amounts of from 0.1% to 2.0%, and more preferably, in amounts of from 0.3% to 1.0%.

Preferably a salt of the hydroxycarboxylic acid such as sodium citrate which is preferred because of its ready availability and contribution to improving physical to improving the physical stability of the composition—i.e., preventing phase separation, as well as providing efficacy against oxidizable stains, e.g., coffee and wine stains. However, other hydroxydi- or hydroxytricarboxylic acids can be employed, such as malic acid, tartaric acid, isocitric acid or tri-hydroxyglutaric acid. The preferred sodium citrate is conveniently used in the form of its dihydrate. Alternatively, citric acid itself may be used in formulating the compositions. However, since the compositions are at an alkaline pH, the hydroxydi- or hydroxytri-carboxylic acid will be present in its ionized salt state. This ingredient is used in an amount ranging of about 5% to about 20% of the entire enzyme-containing composition, preferably amounts of from 8% to 15%, and more preferably in amounts of from 10% to 13%.

An alkali metal chloride, preferably sodium chloride. This ingredient is used in an amount of from about 2% to about 15% based on the weight of the entire enzyme-containing composition, preferably, the chloride ingredient is used in amounts ranging from 4% to 12%, and more preferably from 5% to 8%.

### Surfactant

The preferred enzyme-containing compositions also contain from about 0.05% to about 5% of a C₈-C₁₈ alcohol alkoxylated with 3 to 6 moles of ethylene oxide. A wide variety of alkoxylated fatty alcohols are known to the art and these vary considerably in HLB (hydrophile-lipophile balance). For purposes of this invention, it is preferable to employ an alkoxylated alcohol which is relatively hydrophobic. Preferred surfactants are fatty alcohols having from about 8 about 15 carbon atoms, alkoxylated with about 4 to 6 moles of ethylene oxide. A particularly preferred surfactant is that sold under the trademark Lialet 125 and has a formulation of C₁₂-C₁₅ alcohols alkoxylated with 5 moles of ethylene oxide. These nonionic surfactants are preferably present in the enzyme-containing compositions of this invention in amounts ranging from 0.1% to 2%, more preferably from 0.3% to 1%.

### Additional

To bring the pH to within the desired range of 7.0 to 8.5, a sufficient amount of an acid or an alkali is added to adjust the pH.

The compositions of this invention desirably also contain at least one organic solvent which is preferably water-miscible. Such useful organic solvents include: the linear alcohols such as ethanol, isopropanol and the isomers of butanol; diols; glycols such as ethylene glycol, propylene glycol and hexylene glycol; glycol ethers, etc. Low molecular weight solvents, i.e., those from 1 to 8 carbon atoms, are preferred. A particularly preferred solvent is propylene glycol.

The composition additionally comprises up to 10% wt, 8% wt, 6% wt, 4% wt, 2% wt, 1% wt or 0.5% wt of minor. ingredients selected from one or more of the following: dye, fragrance, preservative, optical brightener, dye transfer inhibitor or a bittering agent.

In order to provide desirable rheologic characteristics to the composition of this invention, thickeners should be added. These include polymeric substances which function as viscosity stabilizers and aid in enzyme stabilization. Exemplary of such polymeric compositions are polyacrylic acid, polymethacrylic acid, acrylic/methacrylic acid copolymers, hydrolyzed polyacrylamide, hydrolyzed polymethacrylamide, hydrolyzed polyacrylonitrile, hydrolyzed polymethacrylonitrile, etc. Water soluble salts or partial salts of these polymers, as well as their respective alkali metal or ammonium salts can also be used. A preferred polymeric substance is sold under the trademark Polygel DA, which is a polyacrylic acid having a molecular weight greater than 1,000,000. These polymers are used in amounts ranging from about 0.1% to 1%, preferably about 0.4%.

A preferred thickening agent is xanthan gum which may be present in an amount of from between 0.1% and 0.5%, preferably about 0.3%. In addition to providing beneficial viscosity characteristics to the compositions, xanthan gum also assists in the removal of certain stains.

The stabilized enzyme-containing compositions of this invention can also include the usual additives usually present in compositions of this type provided, of course, that they do not detract from enzyme stability. Such additives include perfumes, dyes, preservatives, antibacterial agents, fluorescent whitening agents, pigments, etc.

Suitable preservatives include the isothiazolinones sold under the trademark Kathon DP3 and available from Rohm & Haas.

The enzyme-containing compositions may also comprise suspended particles which differ in colour or shade from the aqueous liquid composition. These particles (speckles) can serve an aesthetic purpose and can also provide an additional amount of enzyme stabilizer to the composition. Speckles can be present in amounts ranging from about 0.01 to about 1.0 weight percent. Typically, they will consist of a solid material which can function as an additional stabilizing agent, a coating which melts at a suitable temperature, and a small amount of dye.

The amount of water present in the composition is at least 50% wt, 60% wt, 70% wt or 80% wt.

We have also found that sulphite can function as a hydrogen peroxide destroying agent (in addition or as an alternative to catalase). Thus according to a third aspect of the invention there is provided a liquid detergent composition comprising;
(a) an enzyme sensitive to oxidation;
(b) surfactant;
(c) a hydrogen peroxide destroying agent, preferably a sulphite; and
(d) water

It will be appreciated that features of the first and second aspects of the invention shall apply mutatis mutandis to the third aspect of the invention.

Preferably the sulphite is present in a concentration of 0.015% or greater.

Preferably the sulphite is sodium sulphite.

1. A liquid detergent composition comprising;
(a) an enzyme sensitive to oxidation;
(b) surfactant;
(c) a hydrogen peroxide destroying agent present in an amount of greater than 6 units/ml; and
(d) water.

2. A liquid detergent composition according to claim 1, wherein the hydrogen peroxide destroying agent is catalase.

3. A method of stabilizing a liquid laundry detergent composition containing an enzyme sensitive to oxidation which method comprises the step of: providing a hydrogen peroxide destroying agent to said liquid laundry detergent composition.

4. A method according to claim 3, wherein the hydrogen peroxide destroying agent is catalase.

5. A liquid detergent composition comprising;
(a) an enzyme sensitive to oxidation;
(b) surfactant;
(c) a hydrogen peroxide destroying agent; and
(d) water

6. A liquid detergent composition according to claim 5 wherein the (c) hydrogen peroxide destroying agent is a sulphite.
